(19) United States
(12) Patent Application Publication
(10) Pub. No.: US 2025/0238458 A1
(43) Pub. Date: Jul. 24, 2025

(54) ASSISTED ONTOLOGY BUILDING VIA DOCUMENT ANALYSIS AND LLMS

(71) Applicant: Raytheon Company, Arlington, VA (US)

(72) Inventor: James Ryland, Dallas, TX (US)

(21) Appl. No.: 19/029,436

(22) Filed: Jan. 17, 2025

Related U.S. Application Data
(60) Provisional application No. 63/622,858, filed on Jan. 19, 2024.

(51) Int. Cl. G06F 16/36; G06F 40/30

(52) U.S. Cl. CPC G06F 16/367; G06F 40/30

(57) ABSTRACT

Systems, devices, methods, and computer-readable media for completing an ontology. A method can include providing, to a machine learning (ML) model, unstructured data including a vocabulary of words of an ontology, receiving, from the ML model, a first learned term relationship model indicating respective relationships, the respective relationships indicating which words of the vocabulary of words are related to each other, identifying a relationship of the respective relationships that is (i) present in the first ontology and (ii) absent from a second ontology, providing a prompt including data indicating the relationship to a large language model (LLM), receiving a result from the LLM indicating a type of the relationship, and adding the relationship and the type to the second ontology.

### RELATED APPLICATION

This application claims the benefit of priority to U.S. Provisional Patent Application 63/622,858 titled “Assisted Ontology Building Via Document Analysis and LLMs” and filed on Jan. 19, 2024, which is incorporated herein by reference in its entirety.

### TECHNICAL FIELD

Embodiments regard building ontologies using document analysis and large language models (LLMS).

### BACKGROUND

Ontologies are useful for understanding large structures systems of knowledge. There are few ways to create and grow ontologies automatically from unstructured data. Currently, building ontologies requires leveraging experts and consume a lot of time.

### BRIEF DESCRIPTION OF DRAWINGS

FIG. 1 illustrates, by way of example, a diagram of an embodiment of a system for ontology analysis and completion.

FIG. 2 illustrates, by way of example, a flow diagram of operations that highlights changes to an ontology in an embodiment of the system.

FIG. 3 illustrates, by way of example, a flow diagram of an embodiment of operations performed by a portion of the system of FIG. 1.

FIG. 4 illustrates, by way of example, a flow diagram of an embodiment of operations performed by a portion of the system of FIG. 1.

FIG. 5 illustrates, by way of example, a diagram of an embodiment of a method for ontology building, verification, or a combination thereof.

FIG. 6 is a block diagram of an example of an environment including a system for neural network (NN) training.

FIG. 7 illustrates, by way of example, a block diagram of an embodiment of a machine in the example form of a computer system within which instructions, for causing the machine to perform any one or more of the methods or techniques discussed herein, may be executed.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

Current ontologies built by experts include typed relations (“typed” meaning that the nature of the relationship is specified) that are basically Boolean (“hard”). The relations indicate that corresponding words are related and the relation between the words. Expert time is rare and experts are very time consuming to train. Learned word similarity matrices and embeddings like those found in machine learning (ML) tend to be untyped (meaning that the nature of the relationship is unspecified) and soft. “Soft”, in this context, means that the relationship is associated with a confidence value that is not Boolean. ML models typically indicate that words are related with a specified confidence value. ML models, however, can automatically provide indications as to whether the words are related or whether a word belongs to a class through observation of usage and thus do not require expert time. Large language models (LLMs) are good at parsing language and determining relations explicitly but LLMs can confabulate. Embodiments can use a combination of ML, LLM, and a previously built ontology to identify potential missing links in the previously built ontology. Note, for the purposes of this description, “ML” refers to simpler natural language processing (NLP) learning techniques such as latent semantic analysis (LSA) and word embeddings, but does not refer to sophisticated language generation models like LLMs. LLMs are technically a form of ML but are not included in the term “ML” for ease of this description. Also, although LLMs undoubtably contain loose ontological information, it is in a form that is difficult to directly extract, and is lacking for expert domains.

Embodiments leverage machine learning (ML) technologies to highlight missing links in an ontology. Embodiments can include scanning information sources that are structured, unstructured or a combination thereof. The information sources can include descriptive meta-data and descriptive texts, such as free and open source software (FOSS) descriptive texts. The highlighted missing links give rise to targeted questions that can be formed into a prompt for a large language model (LLM). The prompt can be populated with context. The context can include cross-reference to linked concepts in the ontology with descriptive text. When the LLM gives low confidence answers or cannot tell the relationship between items, the question can then passed to an expert who can discern and provide the relationship or can indicate that the relationship should not be in the ontology. Embodiments put far less onus on experts to maintain and grow an ontology. Embodiments make use of widely available unstructured information on concept domains. Currently there are not many, if any, methods for building and growing ontologies from unstructured data.

The prompt to the LLM can include contextualized forced choices. The choices can indicate the potential relations between the words or potential classes for a single word. The context in the prompt from connected ontology items, which can be built using scraped open-source descriptions, provides the LLM with important information from which the LLM can deduce the relationship or the class without relying on its more limited generalist knowledge. In sum, embodiments can use classic ML text analysis to build an term relationship model that can be compared to a previously built ontology. The comparison can highlight potential missing links in the ontology or new terms that should be added. These highlighted links can then be processed by an LLM with the help of an algorithmically scraped context to identify the appropriate link type. Further, this same method can be used to give a class type for new terms. In this way the highlighting process can help make the ontology more complete.

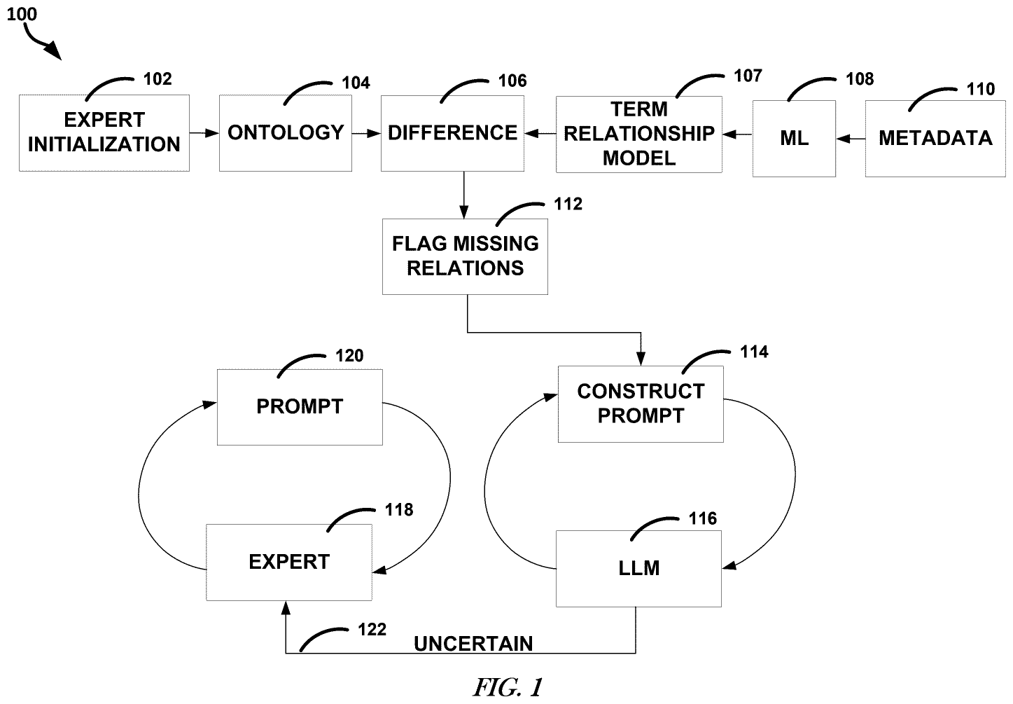

FIG. 1 illustrates, by way of example, a diagram of an embodiment of a system 100 for ontology analysis and completion. The system 100 as illustrated includes an expert initialization operation 102 that generates an ontology 104. The expert initialization operation 102 includes an expert in a field identifying words or concepts (referred to simply as “words” herein for convenience) that are to be part of the ontology 104. The expert also identifies relationships, classes, or a combination thereof for each of the words. The ontology 104 includes the words, classes for the words, relationships for the words, or a combination thereof for each of the words. Each of the respective relationships indicates two words and a nature of the relationship between the two words. For example, consider an example of words “ABI” which stands for Advanced Baseline Imager and “GOES” which stands for Geostationary Operational Environment Satellite. The proper relationship between these words is “ABI belongs to GOES”. An expert can indicate this relationship in the ontology 104. However, experts only have so much time and expert time is expensive, so the ontology 104 is most certainly incomplete. An incomplete ontology can include missing relations between words, classes for words, or a combination thereof.

Metadata 110 can be input into an ML model 108 to generate a separate untyped learned term relationship model 107 for the same vocabulary of the ontology 104. The metadata 110 can include file descriptions and descriptions within databases and other information where the terms of interest are used. The metadata 110 can include, in an example of weather-related data, descriptions of weather datasets that include things like what sensor was used and what types of weather they were monitoring. The metadata 110 is data on which to train the ML model 108 since it includes a lot of the terms of interest being used in context. Also corpus means a training set composed of textual data. Vocabulary works as a term for the set of terms in an ontology.

The ML model 108 can use latent semantic analysis (LSA), or a word embedding technique (e.g., Word2Vec, LSA, GloVe, Bidirectional Encoder Representations from Transformers (BERT)), or the like to learn the relative relatedness between terms. Words within a specified distance of each other in the latent space can be deemed to be related by the ML technique. The vocabulary is the set of words that are included in the ontology. The ontology 104 and learned term relationship model 107 can differ in that the ontology 104 includes hard relations and indicates typed relations. The learned term relationship model 107, in contrast, includes soft relations and does not indicate typed relations.

Differences between the ontology 104 and learned term relationship model 107 can be determined at operation 106. The differences from the operation 106 are illustrated as flagged missing relations 112. The flagged missing relations include potential untyped relations with a confidence above a specified threshold in the learned term relationship model 107 that are not present in the ontology 104. The relations that are in the ontology 104 but are not in the learned term relationship model 107 can be assumed to be valid since they were provided by an expert. Thus, the relations in the ontology 104 that are not in the learned term relationship model 107 may not be in the flagged missing relations 112.

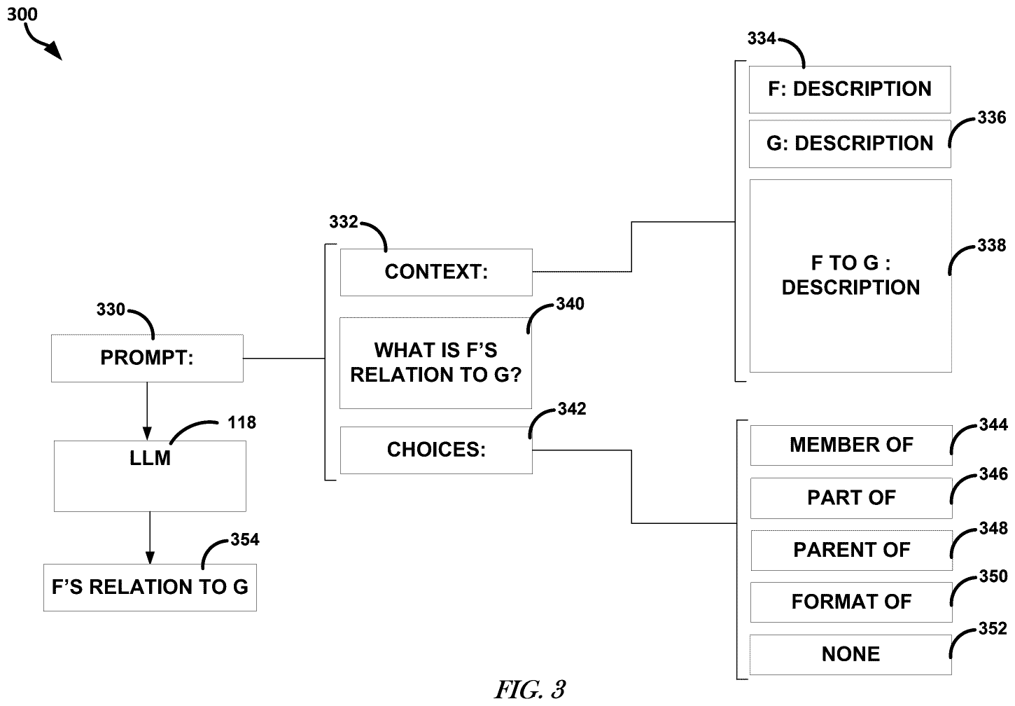

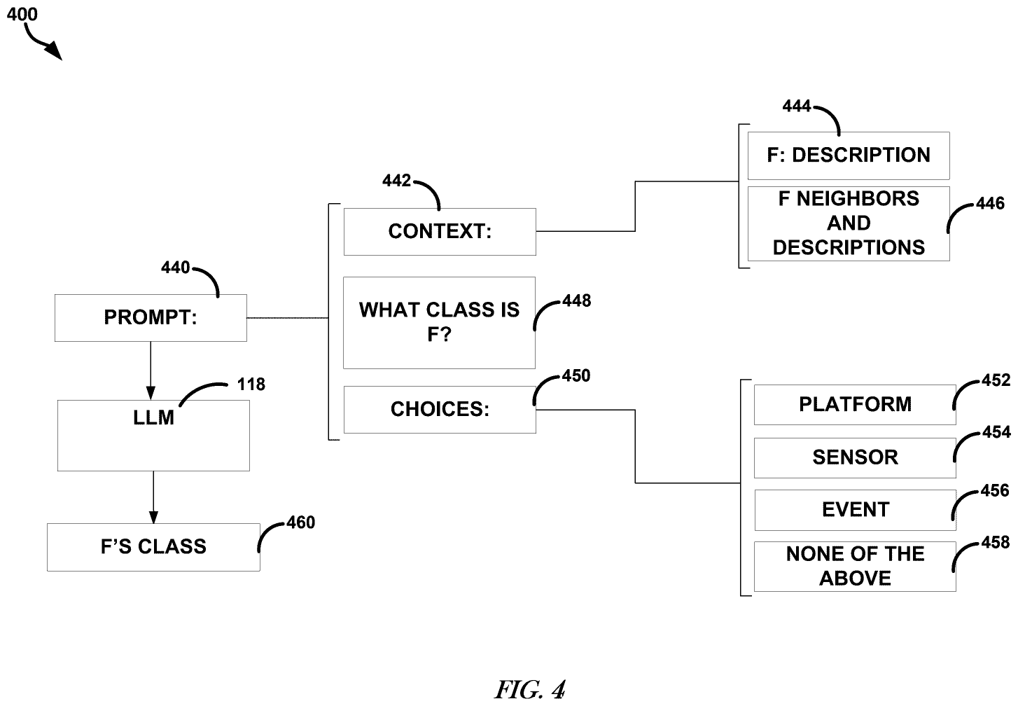

A prompt 120 can be constructed at operation 114. The prompt 120 is discussed in more detail elsewhere, such as regarding FIGS. 3 and 4 and elsewhere. The prompt 120, in general, asks the LLM 116 to determine whether a relation between the missing relation is valid and, if the relation is valid, the type of the relationship. The operation 114 can include automatically generating the prompt. “Automatic” in this context means without human interference after deployment.

An LLM 116 can operate on the prompt constructed at operation 114 to determine the relationship between the words. If the LLM 116 is uncertain 122, an expert 118 can analyze the prompt 120 and identify whether there is a valid relationship between the words and the nature (type) of the relationship. If there is a valid relationship, as determined by the LLM 116, expert 118, or a combination thereof, the words can be related in the ontology 104 along with the relationship type. The result is a more complete ontology that is built at a much lower cost in terms of human and machine resources consumed to generate the ontology as compared to prior expert techniques, ML techniques, or LLM techniques.

Experts are fallible and can miss relations. Experts are also time-constrained and in short supply so expert time is limited, and very expensive. Further, ontology building is often an incredibly tedious task that is likely a poor use of an expert's time. ML techniques do not identify types for relationships and do not provide hard values for relations. LLMs can confabulate, thus making the output potentially incorrect unless it is properly constrained. The system 100 overcomes these issues by leveraging the benefits of experts, simple ML, and LLMs while constraining the disadvantages of each.

Consider a small ontology with a vocabulary of 6,500 words. The ontology can be growing as an expert determines more words that are to be part of the ontology. One way to determine relations between these words would be to determine existence and type of each relation with the LLM 116. However, LLMs are time and resource intensive to run. Even this small ontology of only 6,500 words would take years to build with an LLM alone even provided sufficient prompts. Also, the ontology generated by the LLM would very likely include confabulations, thus manual validation of the ontology would be prudent. The manual validation and amount of time it takes to generate the ontology makes this technique intractable or at least to be avoided.

For 6,500 words, the number of relations to check is Z=(N²−N) R, where N is the number of words and R is the potential relationships between the words. The time to perform checks for all of the relationship using the LLM would be (assuming it takes seven seconds per check which is quite generous using modern LLMs operating on modern technology and a serial uninterrupted check of the relations) about 3,422 days, which is over nine years. This is clearly an unacceptable solution.

Using the system 100, the relationship checks performed by the LLM are significantly lower than using the LLM to build the ontology. The ML model can determine which words are related and confidence scores associated with the relations. The confidence scores can be compared against a threshold confidence score and those relations associated with confidence scores greater than (or equal to) the threshold can be maintained as potential relations. The ML model consumes much less compute bandwidth and compute power as the LLM, so the operation of the ML model is negligible as compared to the operation of the LLM. The LLM does not need to initially identify whether the terms are related because the ML model does a first pass highlighting of missing relations. Instead, the LLM just identifies the type of relations between the words when the words are already highly likely to be related. The compute time in this scenario is on the order of hours or days, instead of years. For example, consider that there are 6,500 terms, but each term only has on average 10 relations to identify and that the LLM takes about seven seconds to identify the type of each relation. The LLM would take about 120 hours to identify all the relations between the 6,500 words (6500*10*7/3600/24=5.3 days).

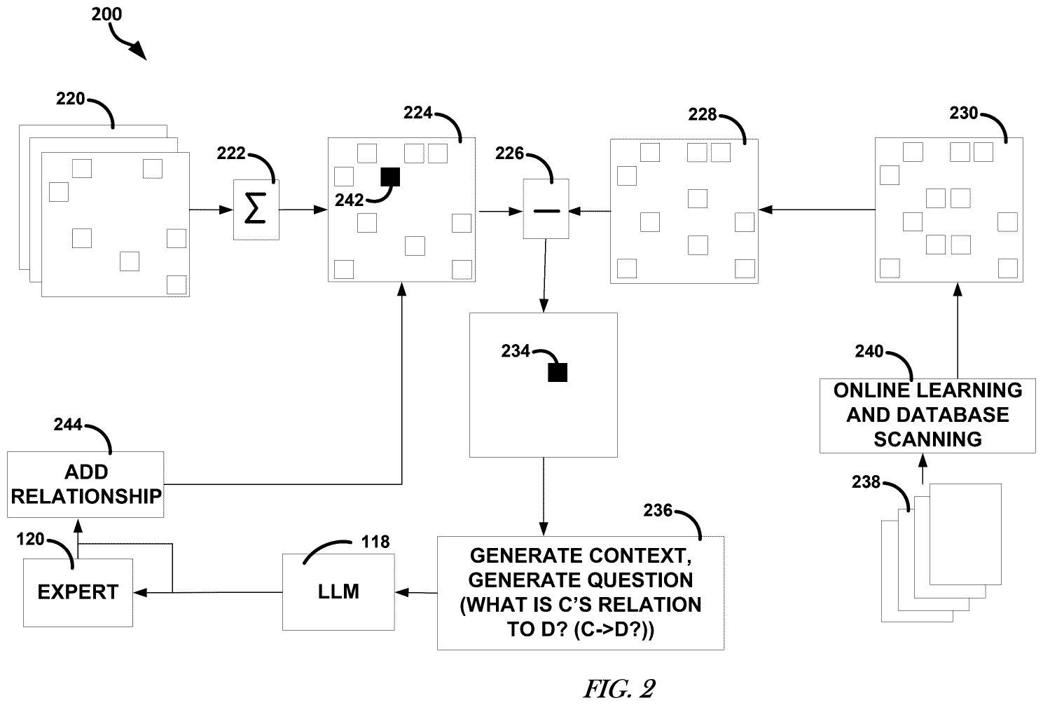

FIG. 2 illustrates, by way of example, a flow diagram of operations 200 that highlights changes to an ontology in an embodiment of the system 100. The operations 200 include one or more experts generating a typed ontology 220 (represented a stack of binary relationship matrices, with a matrix per relationship type). The ontologies 220 are combined by a summation or union operation 222. The ontologies 220 can include same or different vocabulary and can include same or different relations between words in the vocabulary. A condensed ontology 224 is a collapsed version of the expert ontology or ontologies across the relationship type matrices.

Data 238 is unstructured data, structured data, or a combination thereof. Examples of the data 238 include the Wikipedia archive, ArXiv papers, private file databases with domain relevant metadata, documents, or the like. The learning and database scanning operation 240 includes operating the ML model 108 to generate an unhardened-untyped learned term relationship model 230. The unhardened-untyped learned term relationship model 230 is one that includes all potential relations between words, regardless of the confidence that the relation is valid and without regards to the type of relation. A hardened-untyped learned term relationship model 228 that includes only relations associated with confidence levels greater than a specified threshold can be generated based on the unhardened-untyped learned term relationship model 230.

A difference operator 226 compares the hardened learned term relationship model 228 to the expert generated ontology 224. The difference operator 226 identifies any word relationships that are in the hardened learned term relationship model 228 and are not present in the expert generated ontology 224. In the example of FIG. 2, a relationship 234 is present in the hardened learned term relationship model 228 and is not present in the expert generated ontology 224. This relationship 234 can be verified by the LLM 116 and the type of the relationship 234 can be identified by the LLM 116.

Note a relationship 242 can be present in the expert generated ontology 224 but not in the hardened learned term relationship model 228. This is not of concern, since the ontology 224 is generated by an expert and can be assumed to be valid. The relationship 234 that is present in the hardened learned term relationship model 228 but not present in the expert generated ontology 224 is possibly of concern because the hardened-untyped learned term relationship model 228 was not generated by an expert and instead was generated by the ML model 108.

To get the LLM 116 to determine whether the relationship 234 should be included in the ontology 224 and to determine the type of the relationship 234, a prompt can be generated at operation 236. The prompt can include context and a question. More details regarding the prompt are provided elsewhere including in FIGS. 3-4.

The LLM 116 is a large-scale language model. The LLM 116 can achieve general language understanding and generation. The LLM 116 gained this ability by using massive amounts of data to learn billions of parameters during training. LLMs are neural networks (NNs), mainly transformers, that are pretrained using self-supervised and semi-supervised learning. The LLM 116 is trained by taking an input text and repeatedly predicting a next word or token. Example LLMs include generative pre-trained (GPT) models from Open AI, Bard from Google, LLAMA from Meta, BLOOM, Ernie 3.0 Titan, and Claude 2 from Anthropic. While LLMs are excellent at many general language comprehensions tasks, their actual understanding of topics is usually quite shallow and easily fallible. Further, the LLM ability to perform logical inferences with multiple steps is exceedingly limited (especially when the context does not resemble their training data).

The LLM 116 provides data indicating whether a relationship between the words exists and the type of the relationship or a flag indicating that it is uncertain or that a relation does not exist. If the flag indicates that the relation is valid given the contextualized prompt, the relationship can be added to the ontology 224 at operation 244. If the LLM indicates the relationship is invalid, the relationship is not added to the ontology 224. If the LLM indicates uncertainty as to whether the relationship is valid or invalid and or to what its type is, the relationship can be provided to the expert 118. The expert 118 can then decide whether the relationship is added to the ontology 224 at operation 244. In some embodiments, the expert 118 can review all results from the LLM 116 regardless of the confidence. The expert 118 can make the decision as to whether the relationship associated with a given result is added to the ontology 224.

FIG. 3 illustrates, by way of example, a flow diagram of an embodiment of operations 300 performed by a portion of the system 100. The operations 300 include providing a prompt 330 to the LLM 116 and receiving results 354 from the LLM 116. The prompt 330 as illustrated includes context 332, a question 340, and choices 342. The prompt 330, in the example of FIG. 3, is for determining a type of a relationship between two words.

The context 332 indicates a nature of the words that are potentially related according to the ML model 108. These descriptions can include definitions and usages of the two terms that overlap and terms to interrelate to the two terms in question (as inferred from the current state of the ontology). The nature of the words can be provided by respective descriptions 334, 336 of the words of that might be related in the ontology 224. The respective descriptions 334, 336 can include definitions of the terms and related terms from FOSS sources such as Wikipedia, Academic articles, and arXiv pre-prints, examples of usages of the terms from FOSS sources, database metadata, such as file and dataset descriptions, a combination thereof, or the like.

The context 332 further include a description 338 of why the words may be related. The description 338 can include words related to each of the two terms, use of the related words and the terms, definitions of the related words, a combination thereof, or the like.

The question 340, in the example of FIG. 3, asks “what is the relationship between the words associated with the descriptions?” 334, 336, 338. The question 340, in the example of FIG. 3, is “what is F's relation to G?” where F and G are words.

The choices 342 delineate the possible answers that can be provided by the LLM 116. The LLM 116 is thus asked to identify, among the choices 342 provided in the prompt 330, which of the provided choices 342 is the most accurate type of relationship between the words associated with the descriptions 334, 336, 338. There are five choices 344, 346, 348, 350, 352 in the example of FIG. 3, but more or fewer choices can be provided depending on what the ontology 224 is looking to capture. The five choices 344, 346, 348, 350, 352 illustrated include “member of”, “part of”, “parent of”, “format of”, and “none”. The “none” choice is a fallback position if the remainder of the provided choices 342 are determined to be associated with low confidence by the LLM 116. Low confidence means that the none of the above choice has a higher confidence than the remaining choices. This none of the above choice can be broken into multiple types of non-confidence or be followed up with further forced choice questions to ascertain the nature of the uncertainty.

FIG. 4 illustrates, by way of example, a flow diagram of an embodiment of operations 400 performed by a portion of the system 100. The operations 400 include providing a prompt 440 to the LLM 116 and receiving results 460 from the LLM 116. The prompt 440, similar to the prompt 330, as illustrated includes context 442, a question 448, and choices 450. The prompt 440, in the example of FIG. 4, is for determining a class of a word.

The context 442 indicates a nature of the word that is to be classified by the LLM 116. The nature of the word can be provided by a description 444 of the word itself and descriptions 446 of neighbors of the word in the ontology or in the latent space of the ML model 108 when that is lacking. The descriptions 444, 446 can include definitions of the terms and related terms from FOSS sources such as Wikipedia, Academic articles, and arXiv pre-prints, examples of usages of the terms from FOSS sources, database metadata, such as file and dataset descriptions, a combination thereof, or the like.

The question 448, in the example of FIG. 4, asks what is the class of the word associated with the description 444. The question 448, in the example of FIG. 4, is “what class is F?” where F is a word. This question can be asked in multiple ways and does not necessarily have to obey this strict wording.

The choices 450 delineate the possible answers that can be provided by the LLM 116. The LLM 116 is thus asked to identify, among the choices 450 provided in the prompt 440, which of the provided choices 450 is the most accurate class for the word associated with the description 444. There are four choices 452, 454, 456, 458 in the example of FIG. 4, but more or fewer choices can be provided depending on the possible classifications for words in the ontology 224. The four choices 452, 454, 456, 458 illustrated include “platform”, “sensor”, “event”, and “none” are included as an example for a particular domain. The “none” choice is a fallback position if the remainder of the provided choices 450 are determined to be associated with low confidence by the LLM 116. Low confidence meaning that the confidence of the none class is higher than the classification associated with the remaining classes. Again, the none of the above answer can be broken into multiple kinds of uncertainty, and/or trigger follow-up questions to ascertain the nature of the uncertainty.

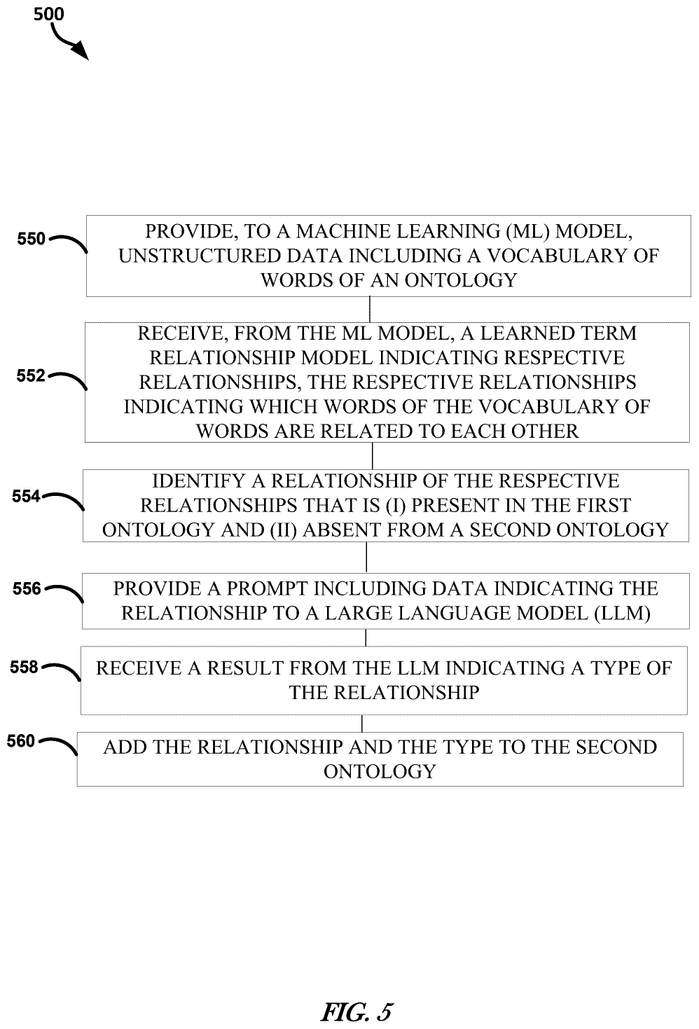

FIG. 5 illustrates, by way of example, a diagram of an embodiment of a method 500 for ontology building, verification, or a combination thereof. The method 500 as illustrated includes providing, to a machine learning (ML) model, unstructured data including a vocabulary of words of an ontology, at operation 550; receiving, from the ML model, a first ontology indicating respective relationships, the respective relationships indicating which words of the vocabulary of words are related to each other, at operation 552; identifying a relationship of the respective relationships that is (i) present in the first ontology and (ii) absent from a second ontology, at operation 554; providing a prompt including data indicating the relationship to a large language model (LLM), at operation 556; receiving a result from the LLM indicating a type of the relationship, at operation 558; and adding the relationship and the type to the second ontology, at operation 560.

The second ontology can be generated based on input from a subject matter expert. The ML model can include word clustering, Word2Vec, Word Embedding, latent semantic analysis (LSA), a semantic analysis model, a term by document analysis, a document-term matrix (DTM) analysis, or an automatic document classification (ADC) technique. The respective relationships can be unhardened relationships.

The method 500 can further include hardening the relationships received from the ML model resulting in hardened relationships. The method 500 can further include wherein identifying is based on only hardened relationships. The prompt can include a description of each word in the relationship. The prompt can further include a description of words related to each of words in the relationship, use of the related words and the words in the relationship, definitions of the related words and the words in the relationship, or a combination thereof. The prompt can further include choices constraining the type of relationship that can be returned by the LLM.

AI is a field concerned with developing decision-making systems to perform cognitive tasks that have traditionally required a living actor, such as a person. NNs are computational structures that are loosely modeled on biological neurons. Generally, NNs encode information (e.g., data or decision making) via weighted connections (e.g., synapses) between nodes (e.g., neurons). Modern NNs are foundational to many AI applications, such as classification, device behavior modeling (as in the present application) or the like. The ML model 108, LLM 116, or other component or operation can include or be implemented using one or more NNs.

Many NNs are represented as matrices of weights (sometimes called parameters) that correspond to the modeled connections. NNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the NN graph—if the threshold is not exceeded then, generally, the value is not transmitted to a down-graph neuron and the synaptic connection remains inactive. The process of weighting and testing continues until an output neuron is reached; the pattern and values of the output neurons constituting the result of the NN processing.

The optimal operation of most NNs relies on accurate weights. However, NN designers do not generally know which weights will work for a given application. NN designers typically choose a number of neuron layers or specific connections between layers including circular connections. A training process may be used to determine appropriate weights by selecting initial weights.

In some examples, initial weights may be randomly selected. Training data is fed into the NN, and results are compared to an objective function that provides an indication of error. The error indication is a measure of how wrong the NN's result is compared to an expected result. This error is then used to correct the weights. Over many iterations, the weights will collectively converge to encode the operational data into the NN. This process may be called an optimization of the objective function (e.g., a cost or loss function), whereby the cost or loss is minimized.

A gradient descent technique is often used to perform objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached—and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used, such as stochastic gradient descent (SGD), Adam, etc.

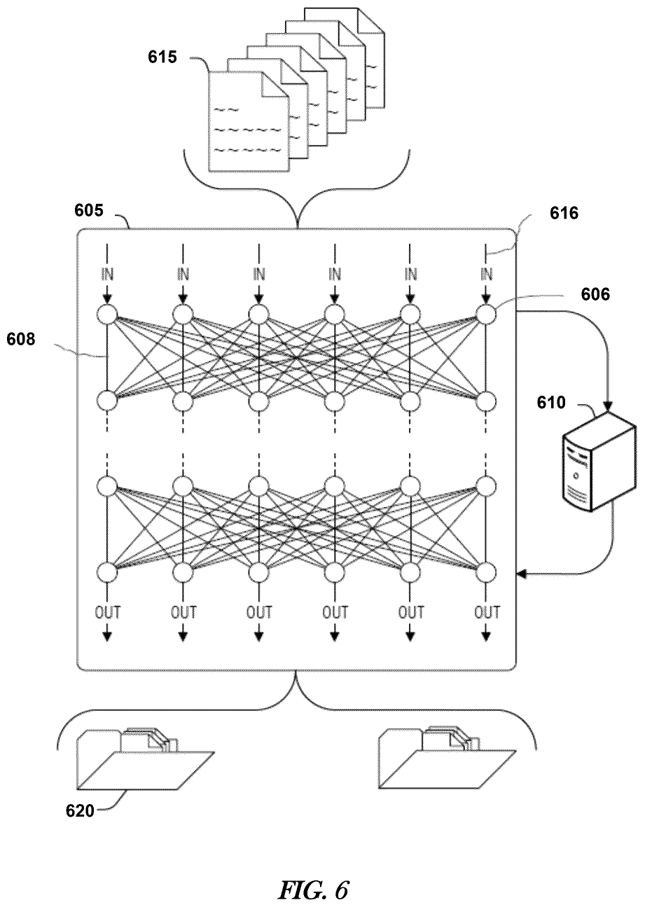

FIG. 6 is a block diagram of an example of an environment including a system for neural network (NN) training. The system includes an artificial NN (ANN) 605 that is trained using a processing node 610. The processing node 610 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the ANN 605, or even different nodes 606 within layers. Thus, a set of processing nodes 610 is arranged to perform the training of the ANN 605. The ML model 108, LLM 116, or the like, can be trained using the system.

The set of processing nodes 610 is arranged to receive a training set 615 for the ANN 605. The ANN 605 comprises a set of nodes 606 arranged in layers (illustrated as rows of nodes 606) and a set of inter-node weights 608 (e.g., parameters) between nodes in the set of nodes. In an example, the training set 615 is a subset of a complete training set. Here, the subset may enable processing nodes with limited storage resources to participate in training the ANN 605.

The training data may include multiple numerical values representative of a domain, such as an image feature, or the like. Each value of the training or input 615 to be classified after ANN 605 is trained, is provided to a corresponding node 606 in the first layer or input layer of ANN 605. The values propagate through the layers and are changed by the objective function.

As noted, the set of processing nodes is arranged to train the neural network to create a trained neural network. After the ANN is trained, data input into the ANN will produce valid classifications 620 (e.g., the input data 615 will be assigned into categories), for example. The training performed by the set of processing nodes 606 is iterative. In an example, each iteration of the training the ANN 605 is performed independently between layers of the ANN 605. Thus, two distinct layers may be processed in parallel by different members of the set of processing nodes. In an example, different layers of the ANN 605 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 606 (e.g., neurons) are trained independently. In an example, the nodes are trained on different hardware.

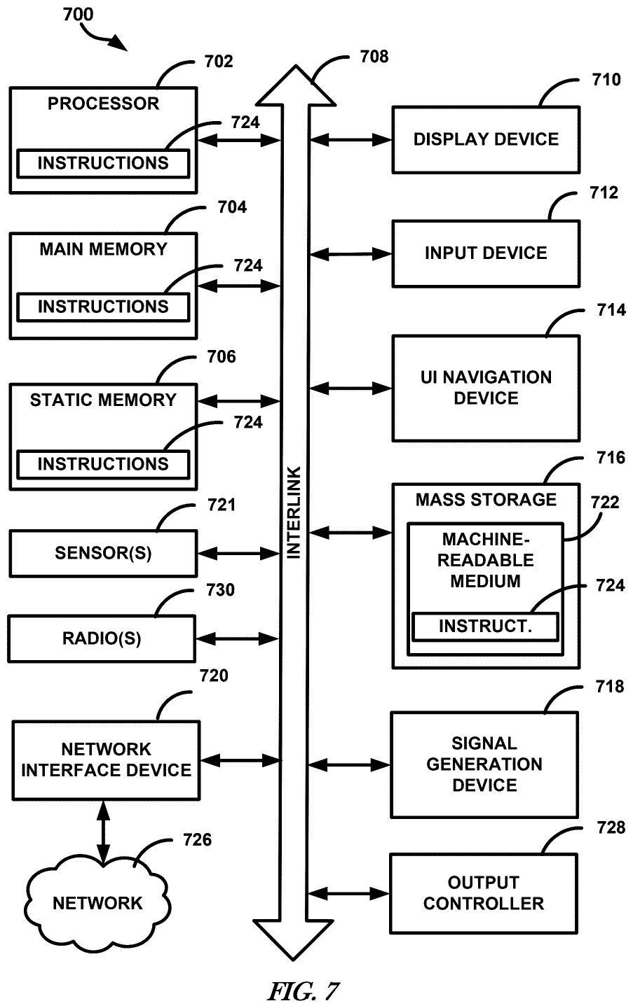

FIG. 7 illustrates, by way of example, a block diagram of an embodiment of a machine in the example form of a computer system 700 within which instructions, for causing the machine to perform any one or more of the methods or techniques discussed herein, may be executed. One or more of the difference operator 106, ML model 108, operation 114, LLM 116, operation 240, method 500, or other component, operation, or technique, can include, or be implemented or performed by one or more of the components of the computer system 700. In a networked deployment, the machine may operate in the capacity of a server or a client machine in server-client network environment, or as a peer machine in a peer-to-peer (or distributed) network environment. The machine may be a personal computer (PC), server, a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation device 714 (e.g., a mouse), a mass storage unit 716, a signal generation device 718 (e.g., a speaker), a network interface device 720, and a radio 730 such as Bluetooth, WWAN, WLAN, and NFC, permitting the application of security controls on such protocols.

The mass storage unit 716 includes a machine-readable medium 722 on which is stored one or more sets of instructions and data structures (e.g., software) 724 embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media.

While the machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding, or carrying instructions for execution by the machine and that cause the machine to perform any one or more of the methodologies of the present invention, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 724 may further be transmitted or received over a communications network 726 using a transmission medium. The instructions 724 may be transmitted using the network interface device 720 and any one of a number of well-known transfer protocols (e.g., HTTPS). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

### ADDITIONAL EXAMPLES

Example 1 includes a method comprising providing, to a machine learning (ML) model, unstructured data including a vocabulary of words of an ontology, receiving, from the ML model, a first learned term relationship model indicating respective relationships, the respective relationships indicating which words of the vocabulary of words are related to each other, identifying a relationship of the respective relationships that is (i) present in the first ontology and (ii) absent from a second ontology, providing a prompt including data indicating the relationship to a large language model (LLM), receiving a result from the LLM indicating a type of the relationship, and adding the relationship and the type to the second ontology.

In Example 2, Example 1 further includes, wherein the second ontology is generated based on input from a subject matter expert.

In Example 3, at least one of Examples 1-2 further includes, wherein the ML model includes word clustering, Word2Vec, Word Embedding, latent semantic analysis (LSA), a semantic analysis model, a term by document analysis, a document-term matrix (DTM) analysis, or an automatic document classification (ADC) technique.

In Example 4, at least one of Examples 1-3 further includes, wherein the respective relationships are unhardened relationships and the method further comprises hardening the relationships received from the ML model resulting in hardened relationships, and wherein identifying is based on (e.g., only) hardened relationships.

In Example 5, at least one of Examples 1-4 further includes, wherein the prompt includes a description of each word in the relationship.

In Example 6, Example 5 further includes, wherein the prompt further includes a description of words related to each of words in the relationship, use of the related words and the words in the relationship, definitions of the related words and the words in the relationship, or a combination thereof.

In Example 7, Example 6 further includes, wherein the prompt further includes choices constraining the type of relationship that can be returned by the LLM.

Example 8 includes a non-transitory machine-readable medium including instructions that, when executed by a machine, cause the machine to perform operations for completing an ontology, the operations comprising the method of one of Examples 1-7.

Example 9 includes a system comprising processing circuitry and a memory coupled to the processing circuitry, the memory including instructions that, when executed by the processing circuitry, cause the processing circuitry to perform operations for completing an ontology, the operations comprising the method of one of Examples 1-7.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. A method comprising:
providing, to a machine learning (ML) model, unstructured data including a vocabulary of words of an ontology;
receiving, from the ML model, a first learned term relationship model indicating respective relationships, the respective relationships indicating which words of the vocabulary of words are related to each other;
identifying a relationship of the respective relationships that is (i) present in the first ontology and (ii) absent from a second ontology;
providing a prompt including data indicating the relationship to a large language model (LLM);
receiving a result from the LLM indicating a type of the relationship; and
adding the relationship and the type to the second ontology.

2. The method of claim 1, wherein the second ontology is generated based on input from a subject matter expert.

3. The method of claim 1, wherein the ML model includes word clustering, Word2Vec, Word Embedding, latent semantic analysis (LSA), a semantic analysis model, a term by document analysis, a document-term matrix (DTM) analysis, or an automatic document classification (ADC) technique.

4. The method of claim 1, wherein the respective relationships are unhardened relationships and the method further comprises:
hardening the relationships received from the ML model resulting in hardened relationships; and
wherein identifying is based on hardened relationships.

5. The method of claim 1, wherein the prompt includes a description of each word in the relationship.

6. The method of claim 5, wherein the prompt further includes a description of words related to each of words in the relationship, use of the related words and the words in the relationship, definitions of the related words and the words in the relationship, or a combination thereof.

7. The method of claim 6, wherein the prompt further includes choices constraining the type of relationship that can be returned by the LLM.

8. A non-transitory machine-readable medium including instructions that, when executed by a machine, cause the machine to perform operations for completing an ontology, the operations comprising:
providing, to a machine learning (ML) model, unstructured data including a vocabulary of words of an ontology;
receiving, from the ML model, a first learned term relationship model indicating respective relationships, the respective relationships indicating which words of the vocabulary of words are related to each other;
identifying a relationship of the respective relationships that is (i) present in the first ontology and (ii) absent from a second ontology;
providing a prompt including data indicating the relationship to a large language model (LLM);
receiving a result from the LLM indicating a type of the relationship; and
adding the relationship and the type to the second ontology.

9. The non-transitory machine-readable medium of claim 8, wherein the second ontology is generated based on input from a subject matter expert.

10. The non-transitory machine-readable medium of claim 8, wherein the ML model includes word clustering, Word2Vec, Word Embedding, latent semantic analysis (LSA), a semantic analysis model, a term by document analysis, a document-term matrix (DTM) analysis, or an automatic document classification (ADC) technique.

11. The non-transitory machine-readable medium of claim 8, wherein the respective relationships are unhardened relationships and the operations further comprise:
hardening the relationships received from the ML model resulting in hardened relationships; and
wherein identifying is based on hardened relationships.

12. The non-transitory machine-readable medium of claim 8, wherein the prompt includes a description of each word in the relationship.

13. The non-transitory machine-readable medium of claim 12, wherein the prompt further includes a description of words related to each of words in the relationship, use of the related words and the words in the relationship, definitions of the related words and the words in the relationship, or a combination thereof.

14. The non-transitory machine-readable medium of claim 13, wherein the prompt further includes choices constraining the type of relationship that can be returned by the LLM.

15. A system comprising:
processing circuitry;
a memory coupled to the processing circuitry, the memory including instructions that, when executed by the processing circuitry, cause the processing circuitry to perform operations for completing an ontology, the operations comprising:
providing, to a machine learning (ML) model, unstructured data including a vocabulary of words of an ontology;
receiving, from the ML model, a first learned term relationship model indicating respective relationships, the respective relationships indicating which words of the vocabulary of words are related to each other;
identifying a relationship of the respective relationships that is (i) present in the first ontology and (ii) absent from a second ontology;
providing a prompt including data indicating the relationship to a large language model (LLM);
receiving a result from the LLM indicating a type of the relationship; and
adding the relationship and the type to the second ontology.

16. The system of claim 15, wherein the second ontology is generated based on input from a subject matter expert.

17. The system of claim 15, wherein the ML model includes word clustering, Word2Vec, Word Embedding, latent semantic analysis (LSA), a semantic analysis model, a term by document analysis, a document-term matrix (DTM) analysis, or an automatic document classification (ADC) technique.

18. The system of claim 15, wherein the respective relationships are unhardened relationships and the operations further comprise:
hardening the relationships received from the ML model resulting in hardened relationships; and
wherein identifying is based on hardened relationships.

19. The system of claim 15, wherein the prompt includes a description of each word in the relationship.

20. The system of claim 19, wherein the prompt further includes a description of words related to each of words in the relationship, use of the related words and the words in the relationship, definitions of the related words and the words in the relationship, or a combination thereof.
